(19) United States
(12) Patent Application Publication
(10) Pub. No.: US 2020/0050950 A1
(43) Pub. Date: Feb. 13, 2020

(54) METHOD AND SYSTEM FOR BUILDING A BEHAVIOR SCHEME

(71) Applicant: Brillianetor Ltd., Tel Aviv- Yaffo (IL)

(72) Inventor: Meirav Hadad Segev, Tel-Aviv (IL)

(21) Appl. No.: 16/485,797

(22) PCT Filed: Feb. 13, 2018
(86) PCT No.: PCT/IL2018/050167

§ 371 Date: Aug. 14, 2019

(30) Foreign Application Priority Data
Feb. 14, 2017 (IL) 250605

(51) Int. Cl. G06N 5/04; G06N 20/20

(52) U.S. Cl. CPC G06N 5/042; G06N 20/20

(57) ABSTRACT

A method for building behavior scheme for an agent is provided. The method includes: receiving data relating to at least one agent, the data including at least one environmental parameter of the at least one agent and a plurality of actions which can be performed by the at least one agent; defining at least one desire to be achieved by the at least one agent; and constructing at least one behavior scheme configured to achieve the desire, the behavior scheme includes at least one action. The execution of the action depends on the environmental parameter.

### CROSS REFERENCES TO RELATED APPLICATIONS

This application is related to and claims priority from commonly owned IL Patent Application Serial No. IL250605 entitled: METHOD AND SYSTEM FOR BUILDING A BEHAVIOR SCHEME, filed on Feb. 14, 2017, the disclosure of which is incorporated by reference in its entirety herein.

### FIELD OF INVENTION

The presently disclosed subject matter relates to a method and system for building a behavior scheme in general and in particular a behavior scheme for agent-based systems.

### BACKGROUND ART

References considered to be relevant as background to the presently disclosed subject matter are listed below:
1. [hereinafter Ghallab2004] Ghallab, M.; Nau, D. and Traverso, P. Automated Planning: Theory & Practice. Morgan Kaufmann, San Francisco, Calif., USA, 2004.
2. [hereinafter Muñoz-Avila99] Muñoz-Avila, H.; Aha, D. W.; Breslow, L. and Nau, D. HICAP: An Interactive Case-Based Planning Architecture and its Application to Noncombatant Evacuation Operations. In Proceedings of AAAI '99/IAAI-99. Pages 870-875. 1999.
3. [hereinafter Nau2003] Nau, D.; Au, T. C.; Ilghami, O.; Kuter, U.; Murdock, J. W.; Wu, D. and Yaman, F. Shop2: An HTN planning system. J. Artif. Intell. Res. (JAIR), 20:379-404, 2003.
4. [hereinafter Russell2010] Russell, S. J. and Norvig, P.; (2010). Artificial intelligence: a modern approach (Third Edition). Prentice Hall PEARSON.
5. [hereinafter Zuckerm2012] Zuckerman, I.; Kraus, S. and Rosenschein, J. S. The adversarial activity model for bounded rational agents. Autonomous Agents and Multi-Agent Systems 24(3):374-409, 2012.

### BACKGROUND

As known in the field of artificial intelligence, an agent is anything that can be viewed as perceiving its environment through types of sensors, and acts upon such an environment through actuators. An agent may be activated (or operated) in a given environment (real or virtual).

An agent refers to both artificial and natural (biological) agents such as humans, (as well as animals), and also to artificial agents such as: a robot; a machine; a software functionality; an application; a computerized system; a computerized entity; a non-player character (NPC); a computer generated forces (CGF); an unmanned vehicle (which includes: unmanned ground vehicle (UGV), such as the autonomous car); unmanned aerial vehicle (UAV), unmanned aircraft commonly known as a “drone”; unmanned combat air vehicle; unmanned surface vehicle (USV), for the operation on the surface of the water; autonomous underwater vehicle (AUV) or unmanned undersea vehicle (UUV), for the underwater operation; unmanned spacecraft, both remote controlled (“unmanned space mission”) and autonomous (“robotic spacecraft” or “space probe”).

Agent's behavior describes sequence of actions that is performed by an agent after any given sequence of precepts.

Editors for building a behavior for an agent are well known. FIG. 1A shows a prior art editor for building a Behavior Tree (BT) for an agent. The editor 2 includes a behavior scheme diagram 4 in which the user can define a scheme for carrying out a behavior, such as play ball and a number of actions and for carrying out the behavior. The editor further includes a list of basic blocks representing executable actions 6, which can be dragged into the behavior scheme diagram 4, as well as a list of perceptional blocks 8. The basic and the perceptional blocks are defined in a domain knowledge base 7 and are given in advance as an input to the editor. A similar editor can be used for building condition-action rules, state machines, etc.

### SUMMARY OF INVENTION

Agent's behavior scheme as used herein the specification and claims refers to set of rules that enables to map a sequence of precepts to actions. Examples of behavior scheme may include: Condition-action rules (also called situation-action rules, productions, or if-then rule), Finite State Machines, A Behavior Tree (BT), Planning Domain Definition Language (PDDL) of planning problem, an Hierarchical Task Network (HTN); and a doctrine.

Root behavior as used herein the specification and claims refers to an assignment or behavior which is to be carried out by an agent in order to achieve a selected desire. The root behavior is to be carried out by means of execution of the actions in the behavior scheme.

Desire as used hereinafter in the specification and claims refers to what the agent ideally wants to see happening (desires may be expressed, for example, as goal, interest, preferences). As defined in [Zuckerm2011], an agent can hold three types of desires with respect to other agents in its environment (a) a cooperative desire; (b) a competitive desire (c) an individual desire;

A desire d, in the desires set Di, of an agent Ai is defined as a cooperative desire with respect to another agent Aj, if Aj also has the desire d (or desire with similar results of desire d) in its desires set. Alternately, desires set Di, is a cooperative if both agents Ai and Aj gain a positive benefit from achieving the desire d, the desire d is defined as a cooperative desire.

A desire d, in the desires set Di, of an agent Ai is defined as a competitive desire with respect to another agent Aj, if the agent Aj also has the contrary of d (or desire with contrary results of desire d) in its desires set. Alternately, one of the agents, Ai, gains a positive benefit from achieving the desire d while the other one, Aj, losses, the desire d is defined as an competitive desire.

A desire d, in the desires set Di, of an agent Ai is defined as an individual desire with respect to another agent Aj, if agent Aj does not have either the cooperative desire d or the competitive desire of d in its desires set. Alternatively, if only one of the agents, Ai, gains a positive benefit from achieving the desire d while the other one, Aj, does not loss but also does not gain any positive benefit from the desire, the desire d is defined as an individual desire.

For example, the desire of agent who plays a football game is “to score more points than its opponent team during the allotted time”. As all the members of its team have the same desire, its desire with respect to its team members is a collaborative desire. In contrast, its desire with respect to members of its opponent team is a competitive desire. More examples of desires are: “to get a master degree”, “to acquire clients”, “to be a champion”.

Condition (also expressed as World-State, Apply-condition, Precondition, Postcondition Result and Effect) as used hereinafter in the specification and claims refers to states of an agent in its environment. Conditions can be defined by defining values to environmental parameters of the agent. Environmental parameters refer to various parameters that describe the agent's environment. For example, environmental parameters of an agent Ai can be: energy level, location, etc. The values of the environmental parameters can be perceived by the agent's sensors.

Constraint as used hereinafter in the specification and claims refers to limitations related to the performing an action or a set of actions or limitations of an agents related to perform an action or a set of actions. For example, a constraint can be the number of agents required for performing an action or the type of agent that can perform an action.

Action as used hereinafter in the specification and claims refers to either basic action or complex action. Basic action is an executable or primitive action and can be directly executed by the agent without being subdivided into sub-actions, e.g., ‘walk’, ‘eat’, ‘be sad’, ‘be happy’. A complex action is one that cannot be executed directly and is decomposed into sub-actions which can be basic actions or other complex actions. If the complex action is decomposed into other sub-complex actions, the sub-complex actions are also built of either complex actions or basic actions.

Recipe as used hereinafter in the specification and claims refers to the description of how to decompose non-primitive actions (i.e., complex actions) into sub-actions (i.e., into simpler ones). For example, the recipe that describes how to decompose the complex action “play-ball” into sub-actions may include the sub-actions: “go to play location” and “play ball loop”. The term recipe can also be described as a method of HTN planning [Nau2003].

There is provided in accordance with an aspect of the presently disclosed subject matter a method for building behavior scheme for an agent, the method includes: receiving data relating to at least one agent, the data including at least one environmental parameter of the at least one agent and a plurality of actions which can be performed by the at least one agent; defining at least one desire to be achieved by the at least one agent; and constructing at least one behavior scheme configured to achieve the desire, the behavior scheme includes at least one action; wherein execution of the action depends on the environmental parameter.

The method can further include defining properties of the desire the properties including a weight value for the desire denoting the level of the importance of the desire.

The properties can further include a utility value representing a ratio between a benefit derived from the behavior scheme and effort in carrying out the behavior scheme.

The properties can further include a utility value representing a ratio between a benefit derived from the behavior scheme and effort in carrying out the behavior scheme.

The properties can further include conditions for fulfilling the desires.

The conditions can include data related to an environment in which the agent operates.

The method can further include defining properties of the behavior scheme including conditions for carrying out the behavior scheme.

The properties can further include parameters of a group of agents executing the behavior scheme.

The behavior scheme can include two or more recipes of actions for executing the behavior scheme.

Each of the recipes can include properties defining conditions for executing the recipes. Each of the recipes can include properties defining constraints for executing the recipes.

The at least one agent includes a plurality of agents each of which can execute one of the recipes depending on the data.

The at least one agent includes a plurality of agents wherein the step of receiving data includes receiving data relating to the plurality of agents including data related to plurality of actions which can be performed by each of the agents; and the step of constructing at least one behavior scheme configured to achieve the desire includes a plurality of actions each of which is to be performed by at least one of the agents; wherein execution of the actions depends on the environmental parameter.

The desire can be a cooperative desire. The cooperative desire can include a first desire and a second desire wherein each one of the plurality of agents is associated with one of the first and second desires and each one of the plurality of agents gains a positive benefit when the plurality of agents achieve the first and second desires.

The desire is a competitive desire. The competitive desire can include a first desire and a second desire wherein each one of the plurality of agents is associated with one of the first and second desires and wherein at least one of the plurality of agents gains a positive benefit from achieving the first desire while another agent of the plurality of agents gains a positive benefit from achieving the second desire, and gains a negative benefit from achieving the first desire.

There is provided in accordance with a further aspect of the presently disclosed subject matter a method for defining a desire for an agent, the method includes: receiving data relating to at least one agent, the data including at least one environmental parameter of the at least one agent; defining at least one root behavior to be performed by the at least one agent so as to achieve the desire; and defining at least one of the environmental parameters which must be fulfilled in order to perform the root behavior.

The method can further include defining properties of the desire the properties including a weight value for the desire denoting the level of the importance of the desire.

The properties further can include a utility value representing a ratio between a benefit derived from the root behavior and effort in carrying out the root behavior.

The properties can further include conditions for fulfilling the desires.

The conditions can include data related to an environment in which the agent operates.

The method can further include defining properties of the root behavior including conditions for carrying out the root behavior.

The method can further include defining properties of the root behavior including constrains for carrying out the root behavior.

There is provided in accordance with a further aspect of the presently disclosed subject matter a computer-implemented method for editing and monitoring behavior scheme for an agent in a graphical user interface, the method includes: displaying in a first window within the graphical user interface data related to at least one agent, the data including at least one environmental parameter of the at least one agent and a plurality of actions which can be performed by the at least one agent; displaying in a second window within the graphical user interface at least one desire to be achieved by the at least one agent; and constructing in a third window within the graphical user interface at least one behavior scheme configured to achieve the desire, the behavior scheme includes at least one action; wherein execution of the action depends on the environmental parameter.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1A is a schematic illustration of a prior art graphical user interfaces (GUI) of an editor for building behavior tree;

FIG. 1B is a schematic illustration of a graphical user interfaces (GUI) of an editor in accordance with an example of the presently disclosed subject matter;

FIG. 1C is a schematic illustration of an exemplary behavior scheme for a single agent built by the behavior diagram panel of the editor of Fig. FIG. 1B;

FIG. 1D is a schematic illustration of an exemplary behavior scheme for multi-agents scheme built by the behavior diagram panel of the editor of FIG. 1B;

FIG. 2A is a schematic illustration of a desire tree panel and desire properties of the editor of FIG. 1B;

FIG. 2B is a schematic illustration of a root behavior properties window showing exemplary environmental parameters;

FIG. 3 is a schematic illustration of showing exemplary recipes built in behavior diagram panel of the editor of FIG. 1B;

FIG. 4 is a schematic illustration of a properties window of an action in the behavior diagram panel of the editor of FIG. 1B;

FIG. 5 is a schematic illustration of a properties window of a recipe in the behavior diagram panel of the editor of FIG. 1B;

FIG. 6 is a flow diagram illustration a method for building a behavioral scheme for an agent in accordance with an example of the presently disclosed subject matter; and,

FIG. 7 is a diagram illustration a method for creating and editing desires in accordance with an example of the presently disclosed subject matter.

### DETAILED DESCRIPTION OF EMBODIMENTS

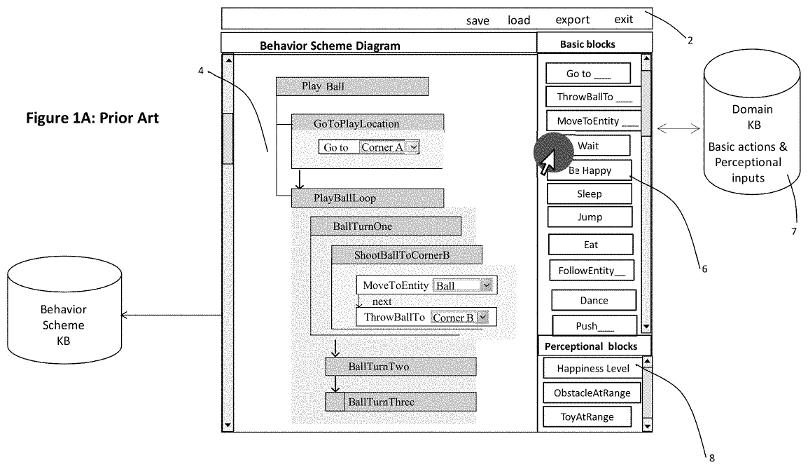

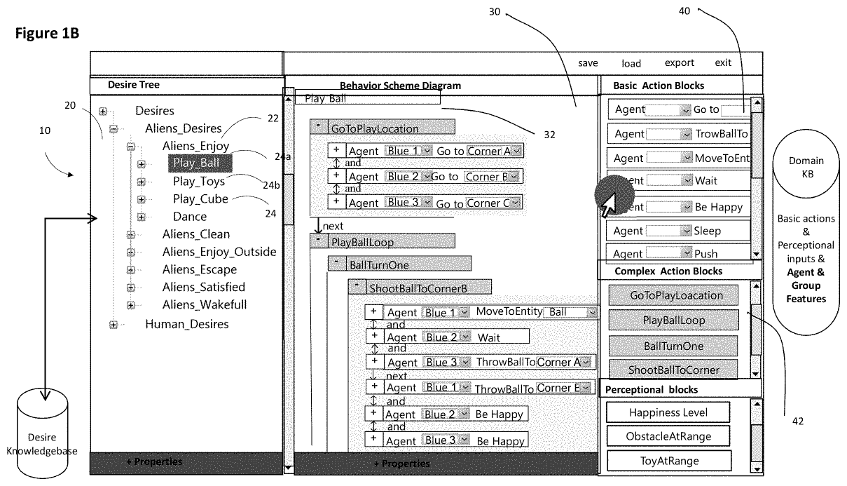

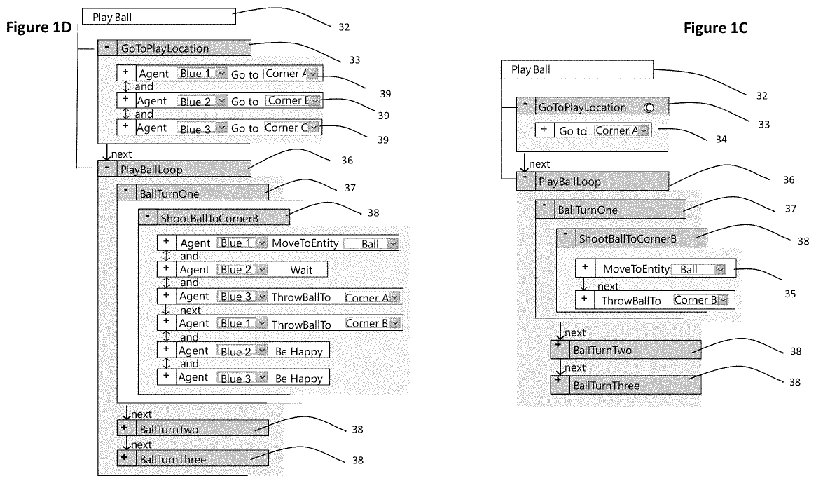

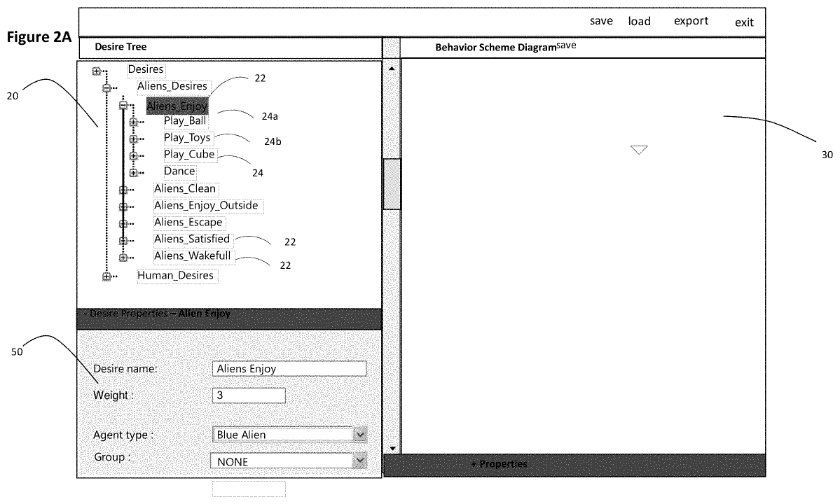

FIG. 1B illustrates a graphical user interfaces (GUI) of an editor 10 for building behavior scheme for a single agent or multiple agents. The editor 10 according to the illustrated example includes a desire tree panel 20, a behavior diagram panel 30 and a behavior block panel 40. The editor 10 is configured to allow constructing a behavior scheme relating to at least one agent, such as an entity in a computer game or an entity representing a system or a physical operator.

The desire tree panel 20 is configured to allow the user to define desires 22 for agents and to further define root behaviors 24 associated with each desire 22. That is to say, if the desire of an agent is to enjoy, the desire tree panel 20 is configured to allow a user to define one or more root behaviors 24 by which the agent can achieve the desire, e.g. to enjoy, such as play balls 24a, play with toys 24b, etc.

The editor 10 is further configured to allow the user to define the root behaviors 24 via the behavior diagram panel 30. According to an example, the selected root behavior, is presented in the behavior diagram panel 30, and allows the user to define a behavior scheme 32 having at least one action to be performed by either one agent or multiple agents.

The user can define the behavior scheme of the root behavior in the behavior diagram panel 30. The behavior diagram can be configured to present the scheme 32 such that each of the steps in the scheme can be expended and defined with actions required for carrying out the step. The actions can be displayed in the action blocks panels 40 and 42. An action can be associated with various properties such as action type, agent, time of performance, and other objects or constraints involved in performing the action. According to an example an action may be either a basic action 40 or a complex action 42. In other words, the scheme is built of basic actions which can be grouped to various complex actions. As will be described hereafter, the decomposition of the complex action into sub-actions is given by a recipe.

In addition, any action may be either a single-agent action or a multi-agent action. That is to say, a single-agent action is an action which can be executed by a single agent alone and a multi-agent action is an action which requires two or more agents to complete.

According to an example, complex actions can include various recipes for execution thereof, and each recipe includes a list of either complex or basic actions to be performed. That is to say, any complex action can be executed in more than one way, which is defined hereinafter as a recipe. A recipe for complex action, can thus include a set of sub-actions and appropriate constraints specifying how the complex action and its sub-actions can be performed.

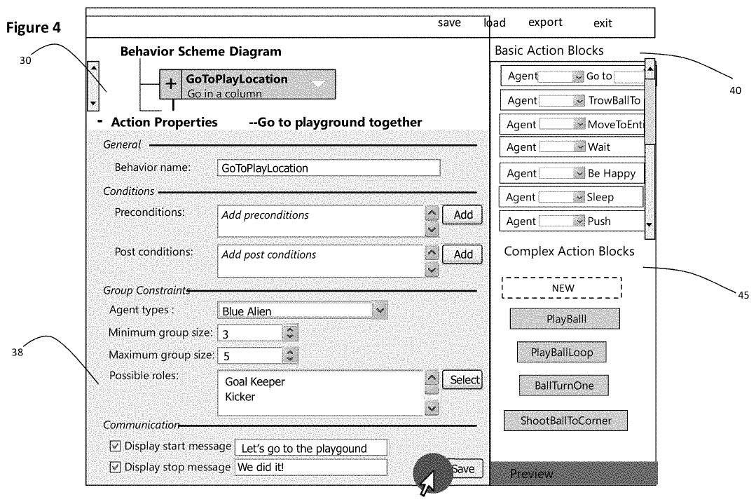

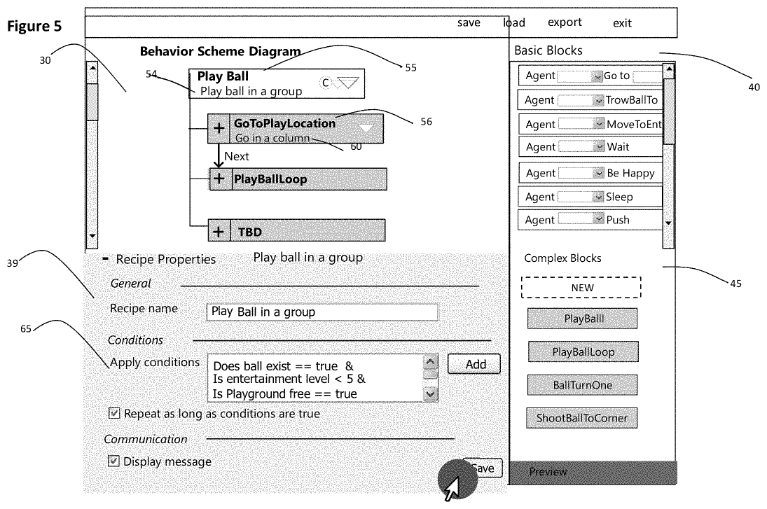

Examples of recipe constraints are agents' constraints. The agents' constraints may specify the capabilities that are required so as to perform specific sub-actions in the recipe. For example, the constraints can be the number of agents required for performing an action in the recipe, such as between 2 and 5 agents. Alternatively, these constraints may specify the type of agent that can perform a certain action, such that for example in a computer games of cars and motorbikes, the constrains may define that the agent for performing a certain action must be a car. According to another example, recipe can include environmental parameters to indicate conditions, preconditions and postconditions for applying the recipe. That is to say, conditions for applying a recipe can be such that if a certain environmental parameter is below a predefined threshold then the agent selects a first recipe while if the parameter is above the threshold the agent selects a second recipe. Setting the parameters for each recipe can be carried out as conditions, as described herein after in connection with FIGS. 4 and 5.

Thus, the recipe describes how to carry out the complex action.

In order to define a recipe for any complex action, the user can drag either basic or complex actions from the basic block panel 40 or the complex block panel 42 into the behavior scheme panel under the appropriated complex action (as a sub-action), displayed in the behavior diagram panel 30.

The list of the basic actions in the basic actions block panel 40 can be uploaded to the editor from a predefined knowledgebase on the agent environment. The user can define with the user interface 10 which agent, will perform each of the basic actions and other parameters pertaining to the appropriate behavior scheme, such as where to go or where to kick the ball etc. The list of the complex actions can be integrated in different behavior schemes which can be built by the user in the behavior diagram panel 30.

FIG. 1C and FIG. 1D, illustrate two different behavior schemes that can be built in the behavior diagram panel 30 for performing the same root behavior, here illustrated as the root behavior of play ball. The root behavior play ball is associated with complex level action “play ball” in the complex action blocks panel 45 (FIG. 4). As a complex level action, this action has at least one recipe that defines the way to perform this action. In this example, the recipe that defines the way to perform the play ball complex action includes two complex sub-actions: ‘Go to play location’ 33 and ‘Play ball loop’ 36. Each of these sub-actions may be performed by a single agent or multiple agents. Thus, the complex action play ball may be either a single-agent action (FIG. 1C) or a multi-agent action (FIG. 1D).

In the example, the Go to play location is defined by two different recipes, the first recipe includes one basic action 34, such that in this case the complex action Go to play location can be executed by a single agent alone. However, the second recipe includes three basic actions 39 and requires three agents to complete the Go to play location action. That is to say, for each complex action there can be a series of actions, which can be carried out by one or more agents. The user can define the number of the required agents for each action and the logical connections between the actions. The logical connection between actions may represent an order relationship such as and, or, next, etc.

For example, ‘next’ relationship may indicate that the sub-action should be done one after the other. For example, first perform the action ‘go to play location’ and then perform the action ‘play ball loop’.

The ‘and’ relationship may indicate that the sub-actions should be done in parallel by different agents. Accordingly, all actions including relative the ‘and’ should be completed successfully. For example, all the agents go together for a certain purpose.

The ‘or’ relationship may indicate that the sub-actions should be done in parallel by different agents. But, in contrast to ‘and’ relationship, only one sub-action should be completed successfully. For example: if there is an enemy. Everyone shoots at the enemy, but it is enough that one of the agents successfully kills the enemy.

It is appreciated that any complex action in the complex blocks panel 42 can have a plurality of recipes by which it can be executed and can allow the user to define various recipes to perform the complex action.

The recipes of any complex action (54, 56) in the behavior scheme 32 can be further defined via the behavior scheme diagram panel 30, by dragging and dropping basic actions or complex actions from the basic or complex blocks panel as explained hereinbefore.

It is appreciated that the basic features of each agent (e.g., its type, its capabilities, its possible roles) and the basic action blocks (which can be carried out by each type of agent) can be provided via predefined database, such as XML, SQL, json etc. and uploaded to the editor 10, such that the user can build the behavior scheme utilizing predetermined features and basic actions. Furthermore, it is appreciated that certain actions can be executed only when certain conditions are met, these conditions are also known as world states and define various propositions and parameters' values of the environment in which each agent operates. Thus, the editor 10 allows the user to provide conditions which define a threshold value of an environmental parameter of each of the agents. For example, an agent, such as an autonomous vehicle can be defined to operate only when the gas level in above a predetermined threshold. Accordingly, the list of the possible environmental parameters of each agent can be predefined, such that the user can set values for each parameter which are defined by these conditions. The environmental parameters are required to define conditions for executing an action or for achieving a desire, as explained hereinafter.

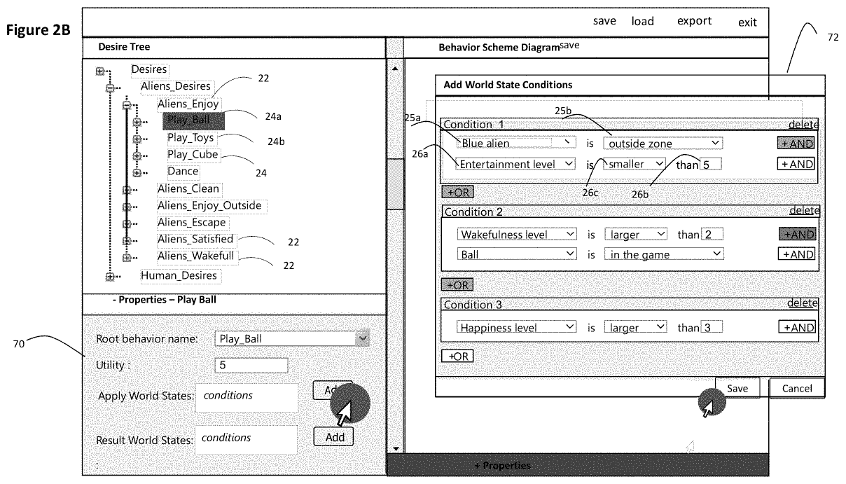

Attention is now made to FIG. 2A and FIG. 2B. The desire tree panel 20 can be configured to allow the user to define desires 22 and properties 50 for each desire, such as weight of the desire, i.e. the level of importance of the desire. This way, if an agent has more than one desire in its desires set, selecting a root behavior can be carried out by taking into consideration which desire the root behavior achieves and the level of importance of achieving this desire. This is important, for example, when in a certain instant the agent can choose between a first root behavior and a second root behavior, when the first root behavior achieves one desire and the second root behavior achieves another desire (e.g., desire to enjoy may be more important from the desire to be clean).

Each desire 22 can be achieved by one or more root behaviors 24. The root behaviors 24 can include additional properties, which can be displayed in a designated properties windows 70. The properties can include a utility value of the root behavior, i.e. whereas weight of desire may denote the level of the importance of the desire, the utility value may represent a ratio between the benefit derived from the root behavior and the effort (or cost) in carrying out the root behavior. That is to say, some root behavior may fulfil a desire having a high weight, while other root behaviors might achieve desires having a lower weight. In addition, execution of some root behaviors might be involved in carrying out many actions and agents with high cost and low utility, while other root behaviors may be easier to execute with low cost and high utility. Thus, the weight and the utility values facilitate the decision-making process of the system when selecting between available desires and the associated root behaviors.

It is appreciated that the utility value of the root behavior may be a predetermined value, or may be a varying value. For example, the value may change depending on the world states (e.g., conditions) of the agent intended to carry out the root behavior.

As shown in FIG. 2B, the properties of the root behaviors may include other properties, such as the type of agent which can carry the root behavior. Since a desire may be achieved by more than one agent the root behaviors can be executed by a group of agents. Thus, the properties of the root behavior can include the group constraints, such as minimum and maximum participants in the group. In addition, the properties can include conditions for fulfilling the desire, such as apply world states, i.e., various conditions in which the agent operates 72. For example, the conditions can include a literal that specifies that the agent should be located in a predefined zone (e.g., the environmental parameter of the blue agent blue alien location 25a is assigned by the value outside zone 25b), or that a certain environmental parameter such as entertainment level 26a is below or higher 26c than a predetermined value 26b, here illustrated as the value 5.

In addition, the properties can include result world states which represent the effect of the desire on the environment of the agent and may be represented as conditions. For example, the ‘enjoy’ desire can include a condition in which an entertainment level is below than a certain value. For example, the result of achieving the desire ‘enjoy’ is an entertainment level that is higher than a certain value. The environmental parameters of the entertainment level is changed by performing the root behavior ‘play ball’ that achieves the desire ‘enjoy’.

It is noted that if different agents try to achieve desires in which the result world states of these desires are contrary (i.e. one result negates the result of the other) then their desires are competitive.

In addition, if different agents try to achieve the same desire, or all of the agents gain a positive benefit from the result, then, their desire may be collaborative and they may join to a group in order to achieve the desire together. For example, the agents can play ball together and by doing so they achieve a collaborative desire to enjoy.

As mentioned hereinbefore, the properties of desire (or its associated root behavior) can also include a definition of which type of agent can fulfil the desire, or in case a desire is achieved by a group of agents (e.g., a cooperative desire), which type of group can achieve the desire and the role of the agent in the group.

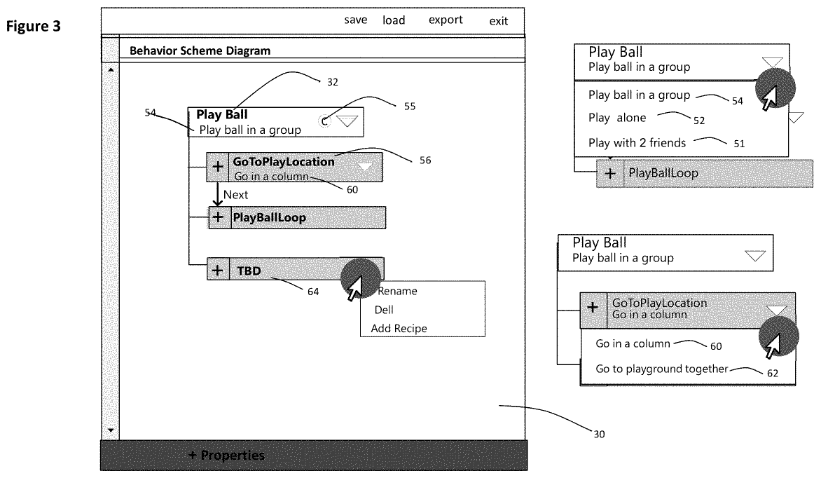

FIG. 3 illustrates the behavior diagram panel 30, in which each root behavior can be built to include a behavior scheme 32. The root behavior 24 according to the illustrated example, refers to playing ball by an agent. Thus, as explained hereinbefore, the root behavior is represented by the complex action ‘play ball’ in the complex blocks panel. The behavior scheme 32 thus, includes various recipes for performing the complex action which represents by the root behavior 24. For example, the agent can play ball by itself (block 52), play ball with two friends (block 51), or play ball in a group (block 54). If the agent chooses to play ball in a group, that means that the agent is trying to achieve a collaborative desire with other agents. In this case, the actions that the agent needs to take with others are: to go the play location (block 56), play ball loop, etc. Carrying out the complex action of going to the play location may also include various recipes for performing it. For example, this action can be done by walking together with other agents (block 62), or by walking in a column (block 60). Next, the actual playing action may be carried out by playing in a circle (block 60). The different steps of the playing ball can be defined by the editor and can include additional steps by which the ball is played (block 64).

As shown in FIGS. 4 and 5, the behavior diagram panel 30 can include a properties section, by which properties for each recipe (block 39) can be defined. Similarly, properties of any action (sub-action in the recipe) can be define as well (block 38). For example, the properties of the recipe can include apply conditions (block 65) which represent the conditions for selecting a specific recipe. As explained hereinabove the conditions can be, for example, a certain value or threshold of value of an environmental parameter.

In addition, according to the illustrated example, a user can define to any sub-action (either complex action or basic action) in the recipe pre-conditions and post conditions, such as defining the location of an agent, the entertainment level, wakefulness level, or any other parameters. To that end, pre-conditions must be fulfilled in order to allow the agent to start the execution of sub-action in a recipe and post-condition must be fulfilled in order to allow the agent to stop the execution of the sub-action. In addition, a user can define, for example, constraints of the group executing the action, such as the maximum and minimum number of agents that are required to carry out the recipe, type of the agents and the necessary roles of the agents to carry-out the sub-actions in the recipe, etc.

A user can also define messages to be display when the agent performs the behaviour or selects a specific recipe (display message at block 39 and block 38). It allows the user to define how to display the communication of the agent with others (e.g., a text or a speech to be displayed). For example, as shown in block 38, when the agent performs the behaviour ‘go to playground’ it may display the message ‘let's go to the playground’.

Thus, according to the present invention the editor can be used for presenting and building different recipes for different agents. In other words, the same behavior scheme, can be executed by a first agent with one recipe and by a second agent with another recipe. This way, the editor allows building behavior scheme which controls the operation of a group of agents and not only a single agent.

Furthermore, the editor allows presenting and defining recipes which include multiple actions each of which can be executed by one or more agents in the group. This way, the recipe can define action to be executed by more than one agent.

As indicated hereinabove each action can include properties pertaining to the type of agent in the group which can execute the action.

A behavior scheme can be presented including the desire, root behavior and all the actions involved with carrying out the scheme. It is appreciated that since, according to the present invention, the root behavior, e.g., play ball, is selected so as to achieve a selected desire. The behavior scheme in which the root behavior is carried out can be configured to verify throughout the execution of the actions that the desire can still be fulfilled. That is to say, the complex actions and the recipe enable flexible construction of behavior scheme based on concrete information of the agent in its environment.

After defining any behavior scheme the user can save or export the behavior to any database, such as XML, SQL, json etc. and to upload the schemes for editing them. The user also can compile the behavior schemes when exporting it. The compiler validates that the scheme does not include any contradiction, such as, internal loops, un-valid constraints, etc.

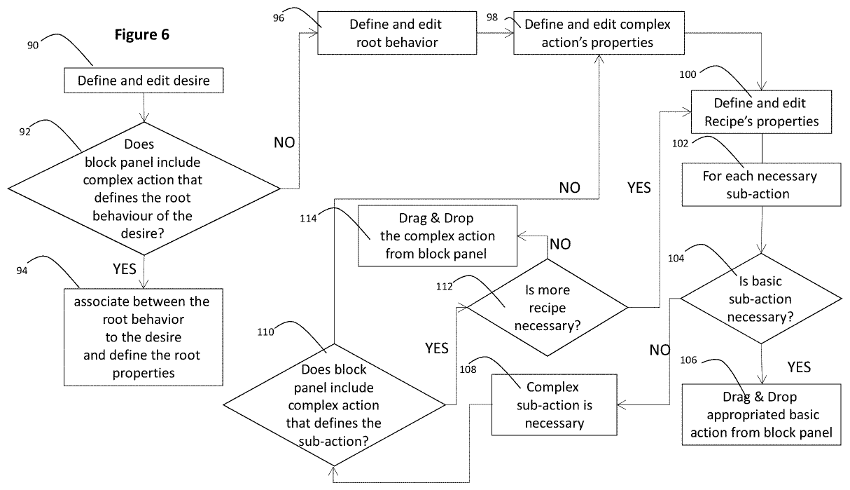

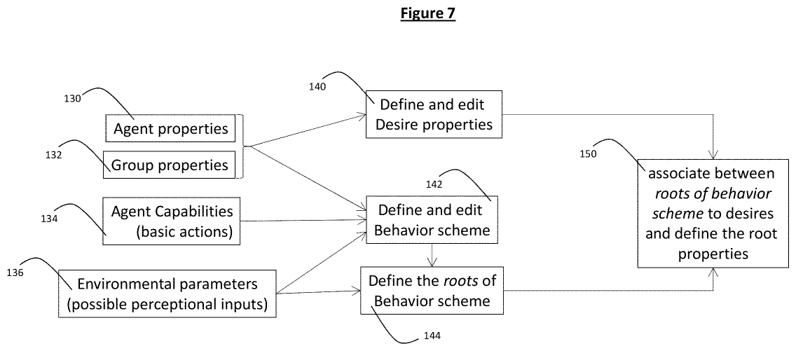

Attention is now directed to FIG. 6, which shows a flow diagram detailing computer-implemented processes in accordance with embodiments of the disclosed subject matter. The aforementioned processes and sub-processes can be, for example, performed manually, automatically, or a combination thereof, and, for example, in real time.

The process begins at block 90, when the user seeks to define and edit a desire for the agent. The process moves to block 92, where it is determined whether the block panel includes a complex action that defines the root behavior of the desire. If, yes, the process moves to block 94, where the root behavior is associated with the desire and the root properties are defined. If no, at block 94, the root behavior is defined and edited, at block 96.

From block 96, the process moves to block 98, where complex action properties are defined and edited. The process moves to block 100, where the recipe's properties are defined and edited. Moving to block 102, sub actions are viewed and for each necessary sub action, it is determined whether a basic sub-action is necessary, at block 104. If yes, the process moves to block 106, where the appropriate basic action is moved, e.g., dropped and dragged, from the block panel. If no at block 104, a complex sub-action is necessary.

From block 108, the process moves to block 110, where it is determined whether the block panel includes a complex action which defines the sub-action. If no, the process moves to block 98, from where it resumes as detailed above. If yes, at block 110, the process moves to block 112, where it is determined whether more recipes are needed. If no, the process moves to block 114, where the appropriate basic action is moved, e.g., dropped and dragged, from the block panel. If yes at block 112, the process moves to block 100, from where it continues, as detailed above.

The editing, defining, dropping and dragging can be done manually or automatically. For example, defining properties to recipe, such as constraints, can be calculated automatically based on the properties of its sub-actions. That is, as each sub-action in the recipe may be associated with its own constraints, then, the recipe's constraints may include the union or the intersection of the constraints of its sub-action.

FIG. 7 shows a diagram for creating and editing desires. This process, for example, includes three steps.

In a first step, input is defined for creating desires and behavior schemes based on the agent environment.

In a second step, behavior scheme and desire properties are created. For example, agent properties 130 and Group properties 132, are used both to define and edit desire properties 140, and define and edit behavior schemes 142. Additionally, agent capabilities 134, e.g., basic actions, are also used to define and edit behavior schemes 142. Environmental parameters, e.g., possible perceptional inputs 136, are used to define and edit behavior schemes 142, and, define roots of the behavior scheme 144.

In a third step, desire hierarchy is defined. This includes associating roots of the behavior scheme to desires, and, to define root properties 150, from blocks 140 and 144.

It is appreciated that terminology such as “mandatory”, “required”, “need” and “must” refer to implementation choices made within the context of a particular implementation or application described herein for clarity and are not intended to be limiting since in an alternative implementation, the same elements might be defined as not mandatory and not required or might even be eliminated altogether.

It is appreciated that software components of the present invention including programs and data can, if desired, be implemented in ROM (read only memory) form including CD-ROMs, EPROMs and EEPROMs, or can be stored in any other suitable typically non-transitory computer-readable medium such as but not limited to disks of various kinds, cards of various kinds and RAMs. Components described herein as software can, alternatively, be implemented wholly or partly in hardware and/or firmware, if desired, using conventional techniques, and vice-versa. Each module or component can be centralized in a single location or distributed over several locations.

Included in the scope of the present invention, inter alia, are electromagnetic signals carrying computer-readable instructions for performing any or all of the steps or operations of any of the methods shown and described herein, in any suitable order including simultaneous performance of suitable groups of steps as appropriate; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; a processor configured to perform any combination of the described steps or to execute any combination of the described modules; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein can be performed by a suitable computerized method. Any step described herein can be computer-implemented. The invention shown and described herein can include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system can, if desired, be implemented as a web-based system employing software, computers, routers and telecommunications equipment as appropriate.

Any suitable deployment can be employed to provide functionalities e.g. software functionalities shown and described herein. For example, a server can store certain applications, for download to clients, which are executed at the client side, the server side serving only as a storehouse. Some or all functionalities e.g. software functionalities shown and described herein can be deployed in a cloud environment. Clients, e.g. mobile communication devices such as smartphones can be operatively associated with but external to the cloud.

The scope of the present invention is not limited to structures and functions specifically described herein and is also intended to include devices which have the capacity to yield a structure, or perform a function, described herein, such that even though users of the device can not use the capacity, they are, if they so desire, able to modify the device to obtain the structure or function.

Features of the present invention which are described in the context of separate embodiments can also be provided in combination in a single embodiment. For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node. Features can also be combined with features known in the art and particularly although not limited to those described in the Background section or in publications mentioned therein.

Conversely, features of the invention, including method steps, which are described for brevity in the context of a single embodiment or in a certain order can be provided separately or in any suitable subcombination, including with features known in the art (particularly although not limited to those described in the Background section or in publications mentioned therein) or in a different order. “e.g.” is used herein in the sense of a specific example which is not intended to be limiting. Devices, apparatus or systems shown coupled in any of the drawings can in fact be integrated into a single platform in certain embodiments or can be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery.

It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

Those skilled in the art to which the presently disclosed subject matter pertains will readily appreciate that numerous changes, variations, and modifications can be made without departing from the scope of the invention, mutatis mutandis

1. A method for building behavior scheme for an agent, the method includes:
receiving data relating to at least one agent, said data including at least one environmental parameter of said at least one agent and a plurality of actions which can be performed by said at least one agent;
defining at least one desire to be achieved by said at least one agent; and
constructing at least one behavior scheme configured to achieve said desire, said behavior scheme includes at least one action;
wherein execution of said action depends on said environmental parameter.

2. The method of claim 1 further comprising defining properties of said desire said properties including a weight value for said desire denoting the level of the importance of said desire.

3. The method of claim 1 wherein said properties further includes a utility value representing a ratio between a benefit derived from said behavior scheme and effort in carrying out said behavior scheme.

4. The method of claim 2 wherein said properties further includes a utility value representing a ratio between a benefit derived from said behavior scheme and effort in carrying out said behavior scheme.

5. The method of claim 2 wherein said properties further includes conditions for fulfilling said desires and wherein said conditions include data related to an environment in which said agent operates.

6. (canceled)

7. The method of claim 1 further comprising defining properties of said behavior scheme including conditions for carrying out said behavior scheme and wherein said properties further includes parameters of a group of agents executing said behavior scheme.

8. (canceled)

9. The method of claim 1 wherein said behavior scheme includes two or more recipes of actions for executing said behavior scheme.

10. The method of claim 9 wherein each of said recipes includes properties defining conditions for executing said recipes.

11. The method of claim 9 wherein each of said recipes includes properties defining constraints for executing said recipes.

12. The method of claim 9 wherein said at least one agent includes a plurality of agents each of which can execute one of said recipes depending on said data.

13. The method of claim 1 wherein said at least one agent includes a plurality of agents wherein said step of receiving data includes receiving data relating to said plurality of agents including data related to plurality of actions which can be performed by each of the agents; and said step of constructing at least one behavior scheme configured to achieve said desire includes a plurality of actions each of which is to be performed by at least one of said agents; wherein execution of said actions depends on said environmental parameter.

14. The method of claim 13 wherein said desire is a cooperative desire and wherein said cooperative desire includes a first desire and a second desire wherein each one of said plurality of agents is associated with one of said first and second desires and each one of said plurality of agents gains a positive benefit when said plurality of agents achieve said first and second desires.

15. (canceled)

16. The method of claim 13 wherein said desire is a competitive desire and wherein said competitive desire includes a first desire and a second desire wherein each one of said plurality of agents is associated with one of said first and second desires and wherein at least one of said plurality of agents gains a positive benefit from achieving said first desire while another agent of said plurality of agents gains a positive benefit from achieving said second desire, and gains a negative benefit from achieving said first desire.

17. (canceled)

18. A method for defining a desire for an agent, the method includes:
receiving data relating to at least one agent, said data including at least one environmental parameter of said at least one agent;
defining at least one root behavior to be performed by said at least one agent so as to achieve the desire; and
defining at least one of said environmental parameters which must be fulfilled in order to perform said root behavior.

19. The method of claim 18 further comprising defining properties of said desire said properties including a weight value for said desire denoting the level of the importance of said desire.

20. The method of claim 18 wherein said properties further includes a utility value representing a ratio between a benefit derived from said root behavior and effort in carrying out said root behavior.

21. The method of claim 19 wherein said properties further includes conditions for fulfilling said desires and wherein said conditions include data related to an environment in which said agent operates.

22. (canceled)

23. The method of claim 19 further comprising defining properties of said root behavior including conditions for carrying out said root behavior.

24. (canceled)

25. A computer-implemented method for editing and monitoring behavior scheme for an agent in a graphical user interface, the method includes:
displaying in a first window within the graphical user interface data related to at least one agent, said data including at least one environmental parameter of said at least one agent and a plurality of actions which can be performed by said at least one agent;
displaying in a second window within the graphical user interface at least one desire to be achieved by said at least one agent; and
constructing in a third window within the graphical user interface at least one behavior scheme configured to achieve said desire, said behavior scheme includes at least one action;
wherein execution of said action depends on said environmental parameter.
